(19) United States
(12) Patent Application Publication
(10) Pub. No.: US 2004/0250102 A1
(43) Pub. Date: Dec. 9, 2004

(54) Apparatus and system for data copy protection and method thereof

(75) Inventors: Yun-sang Kim, Suwon-si (KR); Yang-lim Choi, Sungnam-si (KR); Yun-ho Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/784,777

(22) Filed: Feb. 24, 2004

(30) Foreign Application Priority Data
May 20, 2003 (KR) 10-2003-0032083

(51) Int. Cl. G06F 12/14

(52) U.S. Cl. 713/193

(57) ABSTRACT

The present invention relates to an apparatus and system for data copy protection, and a method thereof. The present invention provides a transmitting apparatus for setting control information for data copy protection, encrypting data by using different encryption processes according to respective control modes corresponding to the set control information, and transmitting the encrypted data; a receiving apparatus for receiving the transmitted encrypted data, extracting the control information from the received data, and decrypting the encrypted data by using different decryption processes according to respective control modes corresponding to the extracted control information; and a system having the transmitting apparatus and the receiving apparatus.

### BACKGROUND OF THE INVENTION

This application claims priority from Korean Patent Application No. 10-2003-0032083, filed on May 20, 2003, in the Korean Intellectual Property Office, and U.S. Provisional Patent Application No. 60/437,203 filed on May 27, 2003, the disclosures of which are incorporated herein in their entireties by reference.

1. Field of Invention

The present invention relates to an apparatus and system for data copy protection and a method thereof, and more particularly, to a method of preventing illegal data copying performed by a third party by adopting different encryption processes according to respective control modes based on control information of data copy protection.

2. Description of the Related Art

With the development of digital signal processing techniques, a variety of digital recording devices and recording media have been widely used. However, since digital data included in such devices and recording media can be repeatedly reproduced and copied, rights of copyright holders, authorized dealers and the like of a variety of contents such as music and movies may be infringed by the distribution of illegally copied recording media. Recently, various methods including a method of using copy control information (hereinafter, referred to as “CCI”) are introduced to prevent an illegal copy of such digital data.

Generally, content providers add in advance designated copy requirements for contents. Therefore, even in case of network communications, there is a need for a sending part to exactly transfer the designated requirements to a receiving part. Accordingly, the CCI is used as copy requirements in the 5C Digital Transmission Content Protection (DTCP) system commonly proposed by five corporations. Such CCI information is represented by a 2-bit code, which can establish four different modes. FIG. 1 shows a conventional structure of CCI information. As shown in FIG. 1, a CCI code of ‘00’ refers to a ‘copy free’ mode in which no encryption has been made and accordingly an audio/video (AV) stream can be freely copied without requiring any authentication or encryption process. A CCI code of ‘01’ refers to a ‘copy free but encrypted’ mode in which an AV stream has been encrypted but it can be freely copied only by a device capable of decrypting the encrypted AV stream. A CCI code of ‘10’ refers to a ‘copy one generation’ mode in which copying is permitted only once while additional copying is prevented. Finally, a CCI code of ‘11’ indicates a ‘no more copy or copy never’ mode in which copying is not permitted.

Where the encryption status represents an ‘encrypted’ state even though the types of CCI codes recorded in AV streams of contents are different from each other, the contents will be regarded as having been recorded using an identical encryption process and will be subjected to an identical decryption process. Thus, where the CCI information is illegally modified, contents that are normally prevented from being copied, i.e. have information of ‘no more copy or copy never,’ may be illegally copied. For example, where a CCI code is modified from the ‘copy one generation’ mode or the ‘no more copy or copy never’ mode to the ‘copy free but encrypted’ mode, contents may be easily decrypted since an identical encryption/decryption process has been applied thereto. Thus, illegal copies of the contents may be repeatedly made. Further, even when a CCI code is illegally modified from the ‘no more copy or copy never’ mode to the ‘copy one generation’ mode, an illegal copy of the contents may still be made.

Moreover, in the conventional art, where the encryption status of the content indicates an ‘encrypted’ state regardless of the importance of the content, an identical encryption/decryption process is applied to an AV stream of the content irrespective of a security level of the content. Thus, the security levels have no significance.

Furthermore, the conventional art does not have compliance rules to check whether a CCI code is valid upon implementation of a system. That is, an implemented hardware or software system is not forced to compare a recorded CCI code with an input data value. Accordingly, such a hardware or software system may not prevent unauthorized modification of the CCI code.

### SUMMARY

An aspect of the present invention is to provide a method of preventing decryption and illegal copying of contents through unauthorized modification of control information of data copy protection by adopting different encryption processes according to respective control modes based on the control information, and maintaining the security of contents by adopting different encryption/decryption processes according to importance of contents (e.g., 11: high, 10: medium, 01: low).

To achieve the above and/or other aspects of the present invention, there is provided a transmitting apparatus for data copy protection, comprising a control information setting unit which sets control information for the data copy protection, a data encrypting unit which encrypts data by using different encryption processes according to respective control modes corresponding to the set control information, and a data transmitting unit which transmits the encrypted data from the data encrypting unit.

To achieve the above and/or other aspects of the present invention, there is provided a receiving apparatus for data copy protection, comprising a data receiving unit which receives hierarchically encrypted data, a control information extracting unit which extracts control information for the data copy protection from the received data, and a data decrypting unit which decrypts the encrypted data by using different decryption processes according to respective control modes corresponding to the extracted control information.

The control information may include copy control information (CCI).

The control mode may include a first mode in which copying is not permitted, a second mode in which copying is permitted once and thereafter additional copying is not permitted, and a third mode in which copying is permitted but the data is encrypted.

The receiving apparatus may further comprise a medium-reproducing device which provides AV stream information to a user.

To achieve the above and/or other aspects of the present invention, there is provided a data copy protection system comprising a transmitting apparatus and a receiving apparatus, wherein the transmitting apparatus sets control information for data copy protection, encrypts data by using different encryption processes according to respective control modes corresponding to the set control information, and transmits the encrypted data, and the receiving apparatus receives the transmitted encrypted data, extracts the control information from the received data, and decrypts the encrypted data by using different decryption processes according to the respective control modes corresponding to the extracted control information.

The control information may include copy control information (CCI).

The control modes may include a first mode in which copying is not permitted, a second mode in which copying is once permitted and thereafter additional copying is not permitted, and a third mode in which copying is permitted but data is encrypted.

The receiving apparatus may further comprise a medium-reproducing device which provides AV stream information to a user.

To achieve the above and/or other aspects of the present invention, there is provided a data copy protection method, the method comprising an operation including setting control information for data copy protection, encrypting data by using different encryption processes according to respective control modes corresponding to the set control information, and transmitting the encrypted data an operation including receiving the transmitted encryption data and extracting the control information from the received data and an operation including decrypting the encrypted data by using different decryption processes according to respective control modes corresponding to the extracted control information.

The control information may include copy control information (CCI).

The control modes may include a first mode in which copying is not permitted, a second mode in which copying is permitted once and thereafter additional copying is not permitted, and a third mode in which copying is permitted but the data is encrypted.

The receiving apparatus may further comprise a medium-reproducing device for providing AV stream information to a user.

To achieve the above and/or other aspects of the present invention, there is provided a recording medium comprising data including control information of copy protection, wherein the data is encrypted by using different encryption processes according to respective control modes corresponding to the control information.

The control information may include copy control information (CCI).

The control modes may include a first mode in which copying is not permitted, a second mode in which copying is permitted once and thereafter additional copying is not permitted, and a third mode in which copying is permitted but data is encrypted.

### BRIEF DESCRIPTION OF THE DRAWINGS

The above and/or other aspects and features of the present invention will become apparent from the following description of preferred embodiments given in conjunction with the accompanying drawings, in which:

FIG. 1 is a table illustrating a conventional encryption status of AV stream data according to copy control information (CCI) codes;

FIG. 2 is a table illustrating an encryption status and relevant encryption/decryption modes of AV stream data according to copy control information codes according to an embodiment of the present invention;

FIG. 3 is a block diagram showing the configuration of a data encryption apparatus according to an embodiment of the present invention;

FIG. 4 is a block diagram showing the configuration of a data decryption apparatus according to an embodiment of the present invention;

FIG. 5A is a flowchart illustrating a data encryption method according to an embodiment of the present invention;

FIG. 5B is a flowchart illustrating a data decryption method according to an embodiment of the present invention;

FIG. 6 is a block diagram showing the configuration of a data decryption apparatus with three types of 2-bit codes according to another embodiment of the present invention; and

FIG. 7 is a block diagram showing the configuration of a data decryption apparatus using three types of DES ciphers according to yet another embodiment of the present invention.

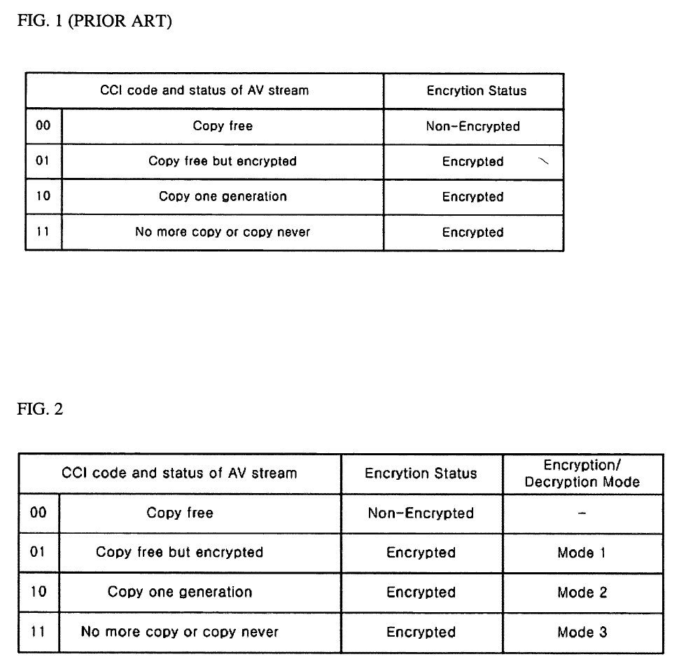

### DETAILED DESCRIPTION

Hereinafter, an apparatus and system for data copy protection and a method thereof according to preferred embodiments of the present invention will be described in detail with reference to the accompanying drawings.

By way of an example, the present invention will be described where data refers to contents including AV stream data and control information for copy protection refers to CCI.

FIG. 2 shows an encryption status and relevant encryption/decryption modes of AV stream data according to copy control information codes according to an embodiment of the present invention. According to an embodiment of the present invention, different encryption/decryption modes for contents are established to prevent illegal copying that may be realized by modification of CCI codes. A CCI code of ‘01’ refers to a first mode representing ‘copy free but encrypted,’ a CCI code of ‘10’ refers to a second mode representing ‘copy one generation,’ and a CCI code of ‘11’ refers to a third mode representing ‘no more copy or copy never.’

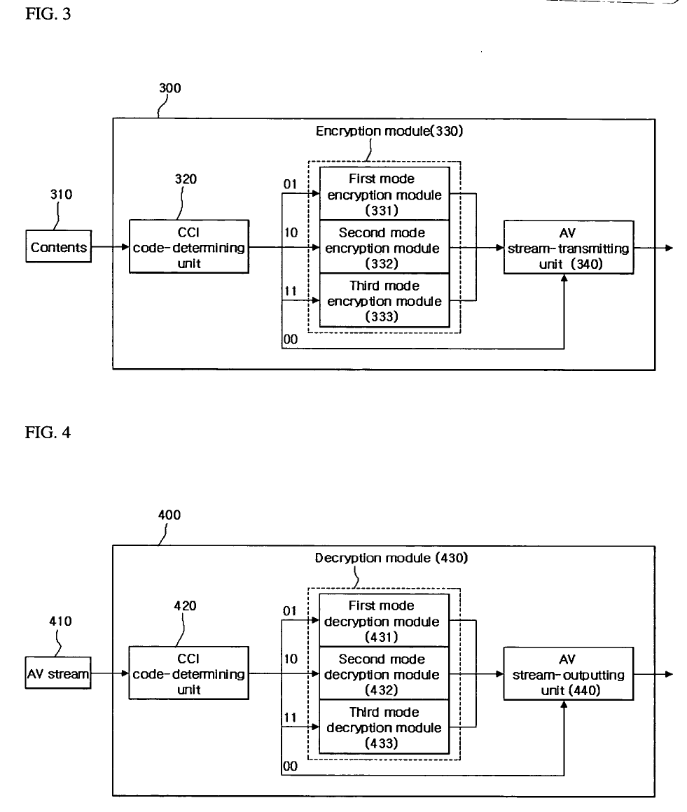

FIG. 3 shows the configuration of a data encryption apparatus having a transmitting apparatus 300 according to an embodiment of the present invention. The transmitting apparatus 300 for data copy protection comprises a CCI code-determining unit 320, an encryption module 330 which encrypts AV stream data, and an AV stream transmitting unit 340 which transmits the encrypted or non-encrypted AV stream.

The CCI code-determining unit 320 determines which CCI code is added to the AV stream to encrypt contents 310. Where the determined CCI code is ‘00’, i.e. ‘copy free,’ the AV stream does not pass through the encryption module 330 and is stored in a recording medium or transmitted through a transmission medium via the AV stream transmitting unit 340 without being encrypted by the encrypting module 330. Where the determined CCI code is one of ‘01’, ‘10’ and ‘11’ representing ‘copy free but encrypted,’ ‘copy one generation’ and ‘no more copy or copy never,’ respectively, the AV stream of the contents is encrypted by the encryption module 330 by way of different encryption modes and stored in a recording medium or transmitted through a transmission medium via the AV stream transmitting unit 340. That is, the AV stream is encrypted by encryption modules 331, 332 and 333 for the first, second and third encryption modes in the encryption module 330 where the determined CCI codes are ‘01,’ ‘10’ and ‘11,’ respectively.

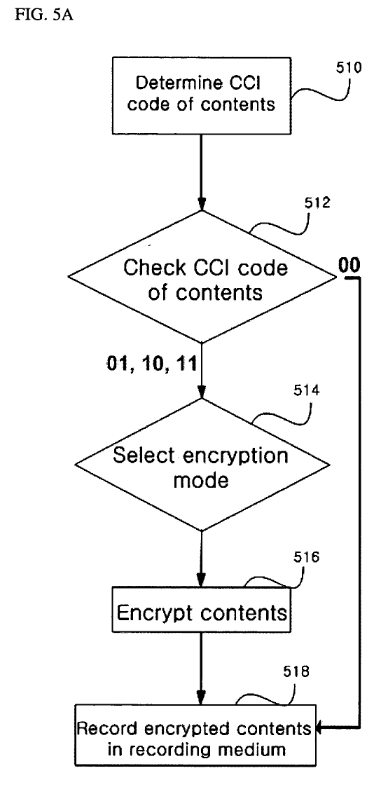

FIG. 4 shows the configuration of a data decryption apparatus having a receiving apparatus 400 according to an embodiment of the present invention. The receiving apparatus 400 for data copy protection comprises a CCI code-checking unit 420, a decryption module 430 which decrypts an AV stream 410, and an AV stream-outputting unit 440 which outputs the decrypted or non-decrypted AV stream. The CCI code-checking unit 420 checks a CCI code held by the received AV stream 410. Where the CCI code of the AV stream is ‘00’ representing ‘copy free,’ the AV stream is directly output via the AV stream-outputting unit 440 without passing through the decryption module 430. Where the CCI code is ‘01,’ ‘10’ and ‘11’ representing ‘copy free but encrypted,’ ‘copy one generation’ and ‘no more copy or copy never,’ respectively, the AV stream is decrypted by different decryption modules 431, 432 and 433, respectively and output via the AV stream-outputting unit 440. That is, the AV stream is decrypted by the first mode decryption module 431 in case of ‘01,’ the second mode decryption module 432 in case of ‘10,’ and the third mode decryption module 433 in case of ‘11,’ respectively, and output via the AV stream-outputting unit 440.

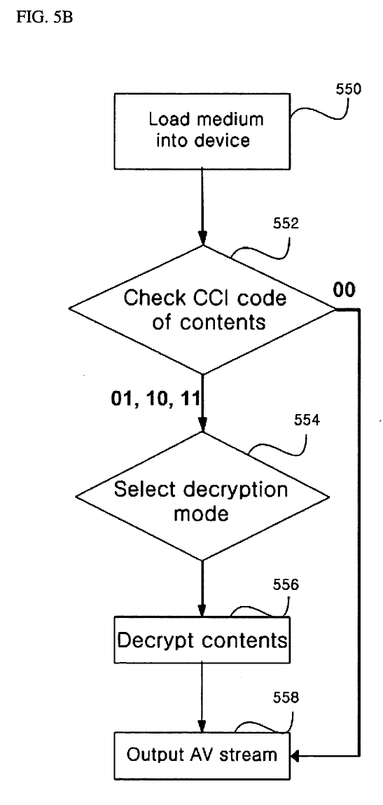

FIG. 5A shows a flowchart illustrating a data encryption method according to an embodiment of the present invention. In operation 510, contents are received and a CCI code is determined according to information on the contents. In operation 512, the determined CCI code is checked. Where the checked CCI code is ‘00,’ the contents are recorded in a medium, for example, an optical recording medium without being encrypted in operation 518. Where the CCI code is not ‘00,’ an encryption mode corresponding to this CCI code is selected in operation 514. That is, where the code is ‘01,’ ‘10’ and ‘11,’ the first, second and third modes are selected, respectively. After the selection of the encryption mode, an encryption process corresponding to the selected mode is performed on the contents in operation 516 and the encrypted contents are recorded in the medium such as an optical recording medium in operation 518.

According to an aspect of the present invention, the encrypted contents may be transmitted through a wired/wireless transmission medium to an apparatus for decrypting the encrypted contents instead of recording the same in the recording medium.

FIG. 5B shows a flowchart illustrating a data decryption method according to an[other] embodiment of the present invention. A medium, for example, an optical recording medium having data is loaded into an apparatus for decrypting encrypted data in operation 550. In another aspect, data may be received through a wired/wireless transmission medium instead of the recording medium. A CCI code in the data received from the recording medium or through the transmission medium is checked in operation 552. Where the CCI code is ‘00,’ the received contents are directly output as an AV stream without being decrypted. Where the CCI code is not ‘00,’ an encryption mode corresponding to the CCI code is selected in operation 554. That is, where the code is ‘01,’ ‘10’ and ‘11,’ the first, the second and the third modes are selected, respectively. After the selection of the encryption mode, the contents are decrypted according to the selected encryption mode in operation 556 and an AV stream of the decrypted contents is output in operation 558.

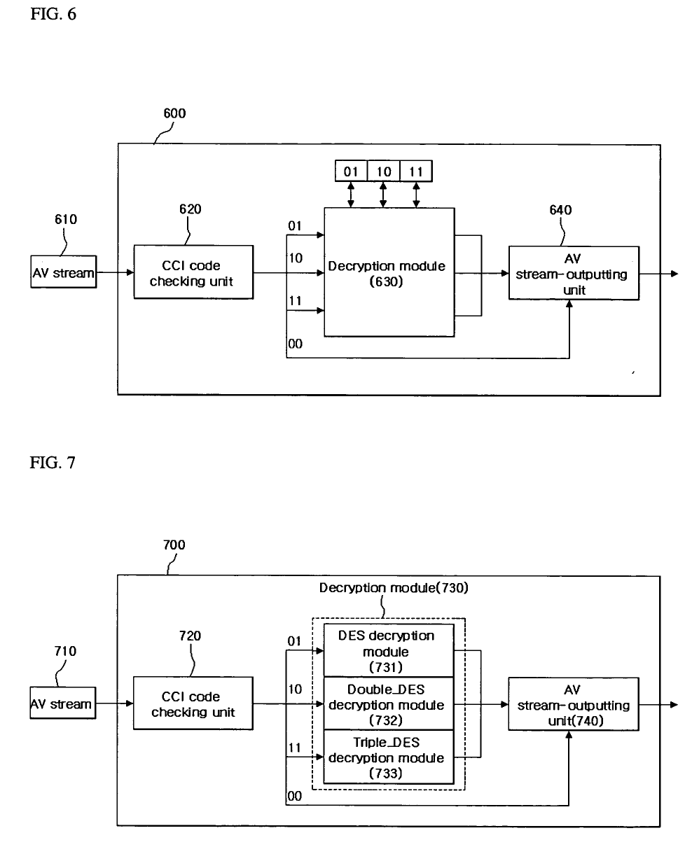

FIG. 6 shows the configuration of a data decryption apparatus with three types of 2-bit codes according to another embodiment of the present invention. The data decryption apparatus 600 receives an AV stream 610, and a CCI code checking unit 620 checks a CCI code in the received AV stream. Where the CCI code is ‘00,’ the AV stream is directly output through an AV stream-outputting unit 640 without passing through a decryption module 630. Where the CCI code is one of ‘01,’ ‘10’ and ‘11,’ the decryption module 630 inserts the same code as the CCI code into a most significant bit (MSB) or least significant bit (LSB) of a key code for use in decrypting the contents. Where the CCI code was modified illegally, the contents cannot be decrypted since a key different from a key used for encrypting the contents is created. The AV stream decrypted in such a manner is output through the AV stream-outputting unit 640.

FIG. 7 shows the configuration of a data decryption apparatus using three types of data encryption standard (DES) ciphers according to still another embodiment of the present invention.

A DES cipher is a symmetrical key cipher including encryption and decryption keys. The DES cipher was developed by IBM Corporation in late 1960's and has been adopted as the standard encryption algorithm in 1977. As a result, it is used in a variety of fields including monetary facilities in the world due to its high processing speed. The DES cipher is a symmetrical block cipher that includes a plaintext having a block length of 64 bits, a 64-bit key (in practice, including 56 bits for a key and 8 bits for checking), and a 64-bit cryptogram. In a DES algorithm, a 64-bit plaintext is subjected to a Feistel operation of 16 rounds, resulting in a 64-bit cryptogram.

A double_DES is an algorithm for performing DES twice by using 112 bits of two different 56-bit encryption keys, and a triple_DES is an algorithm for performing DES three times by using 112 bits of two different 56-bit encryption keys.

In the present invention, where the CCI code is ‘01,’ ‘10’ and ‘11,’ a DES decryption module 731, a double_DES decryption module 732 and a triple_DES decryption module 733 of a decryption module 730 are operated, respectively. Keys used in the respective decryption modules 731, 732 and 733 are the same as keys used in encryption.

Although the method of implementing different control modes according to the CCI codes has been described in the present invention, it is understood that other methods may be used to meet a particular method of changing encryption/decryption processes resulting in diversity of security levels such as high, medium and low, and a method of inserting a CCI code into a data area where copy is not permitted, to perform comparison of relevant CCI codes so as to prevent further processing where the relevant CCI codes do not match with each other, or to utilize the inserted CCI code as input data of a key for use in encrypting/decrypting contents.

According to the present invention, illegal data copying by a third party can be prevented more effectively, and data can be more stably protected according to the importance of the data.

Since those skilled in the art can make various substitutions, changes and modifications to the embodiments of the present invention described above without departing from the technical spirit and scope of the invention, the present invention is not limited to the embodiments illustrated in the drawings.

What is claimed is:

1. A transmitting apparatus for data copy protection, comprising:
a control information setting unit which sets control information for the data copy protection;
a data encrypting unit which encrypts data by using different encryption processes according to respective control modes corresponding to the set control information; and
a data transmitting unit for transmitting the encrypted data from the data encrypting unit.

2. A receiving apparatus for data copy protection, comprising:
a data receiving unit for receiving encrypted data;
a control information extracting unit which extracts control information for the data copy protection from the received data; and
a data decrypting unit which decrypts the encrypted data by using different decryption processes according to respective control modes corresponding to the extracted control information.

3. The receiving apparatus as claimed in claim 2, wherein the encrypted data comprises hierarchically encrypted data.

4. The apparatus as claimed in claim 1, wherein the control information comprises copy control information (CCI).

5. The apparatus as claimed in claim 1, wherein the control modes comprise a first mode in which copying is not permitted, a second mode in which copying is permitted once and thereafter additional copying is not permitted, and a third mode in which copying is permitted but the data is encrypted.

6. The apparatus as claimed in claim 3, wherein the receiving apparatus further comprises a medium-reproducing device for providing AV stream information to a user.

7. A system for data copy protection, comprising:
a transmitting apparatus which provides control information for the data copy protection, encrypts data by using different encryption processes according to respective control modes corresponding to the control information, and transmits the encrypted data; and
a receiving apparatus which receives the transmitted encrypted data, extracts the control information from the received data, and decrypts the encrypted data by using different decryption processes according to the respective control modes corresponding to the extracted control information.

8. The system as claimed in claim 7, wherein the control information includes copy control information (CCI).

9. The system as claimed in claim 7, wherein the control modes comprise a first mode in which copying is not permitted, a second mode in which copying is once permitted and thereafter additional copy is never permitted, and a third mode in which copying is permitted but the data is encrypted.

10. The system as claimed in claim 7, wherein the receiving apparatus further comprises a medium-reproducing device which provides AV stream information to a user.

11. A data copy protection method, comprising:
setting control information for data copy protection, encrypting the data by using different encryption processes according to respective control modes corresponding to the set control information, and transmitting the encrypted data;
receiving the transmitted encrypted data and extracting the control information from the received data; and
decrypting the encrypted data by using different decryption processes according to the respective control modes corresponding to the extracted control information.

12. The method as claimed in claim 11, wherein the control information includes copy control information (CCI).

13. The method as claimed in claim 11, wherein the control modes comprise a first mode in which copying is not permitted, a second mode in which copying is permitted once and thereafter additional copying is not permitted, and a third mode in which copying is permitted but the data is encrypted.

14. A recording medium comprising data including control information for copy protection, wherein the data is encrypted by using different encryption processes according to respective control modes corresponding to the control information.

15. The recording medium as claimed in claim 14, wherein the control information comprises copy control information (CCI).

16. The recording medium as claimed in claim 14, wherein the control modes comprise a first mode in which copying is not permitted, a second mode in which copying is permitted once and thereafter additional copying is not permitted, and a third mode in which copying is permitted but the data is encrypted.

17. The apparatus as claimed in claim 2, wherein the control information comprises copy control information (CCI).

18. The apparatus as claimed in claim 2, wherein the control modes comprise a first mode in which copying is not permitted, a second mode in which copying is permitted once and thereafter additional copying is not permitted, and a third mode in which copying is permitted but the data is encrypted.

19. An encrypting apparatus for data copy protection, comprising a data encrypting unit which encrypts data by using different encryption processes according to respective control modes corresponding to set control information for the data copy protection.

20. The apparatus as claimed in claim 19, wherein the data encrypting unit comprises encryption modules corresponding to the control modes.

21. A decrypting apparatus for data copy protection, comprising a data decrypting unit which decrypts encrypted data by using different decryption processes according to respective control modes corresponding to set control information for the data copy protection.

22. The apparatus as claimed in claim 21, wherein the data decrypting unit comprises decryption modules corresponding to the control modes.

23. The apparatus as claimed in claim 22, wherein decryption modules include a data encryption standard (DES) decryption module, a double-DES decryption module, and a triple-DES decryption module.

24. A decrypting apparatus for data copy protection, comprising:
a code checking unit which checks copy control information (CCI) code of received data; and
a decryption module which inserts a same code as the CCI code into one of a most significant bit (MSB) and a least significant bit (LSB) of a key code for use in decrypting the data, in response to the CCI code being one of predetermined codes for controlling copying of the data.

25. A system for data copy protection, comprising:
an encrypting unit which encrypts data by using different encryption processes according to respective control modes corresponding to set control information for the data copy protection; and
a decrypting unit which decrypts the data by using different decryption processes according to the respective control modes corresponding to the set control information for the data copy protection.

26. The system as claimed in claim 25, wherein the respective control modes are established for the data so as to prevent unauthorized copying of the data through modification of the set control information.

27. A method of encrypting data for data copy protection, the method comprising encrypting the data using different encrypting processes according to respective control modes corresponding to set control information for the data copy protection.

28. A method of decrypting encrypted data for data copy protection, the method comprising decrypting the encrypted data using different decrypting processes according to respective control modes corresponding to set control information for the data copy protection.

29. A data copy protection method for data, the method comprising:
encrypting the data using different encrypting processes according to respective control modes corresponding to set control information for the data copy protection; and
decrypting the encrypted data using different decrypting processes according to the respective control modes corresponding to the set control information for the data copy protection.

30. An information storage medium comprising:
data; and
control information for data copy protection, wherein the data is encrypted/decrypted using different encryption/decryption processes according to respective control modes corresponding to the control information.

31. The information storage medium as claimed in claim 30, wherein the respective control modes are established for the data so as to prevent unauthorized copying of the data through modification of the control information.
